(19) United States
(12) Patent Application Publication
(10) Pub. No.: US 2002/0158921 A1
(43) Pub. Date: Oct. 31, 2002

(54) Method and apparatus for virtual oversized display using a small panel display as a movable user interface

(76) Inventor: D. Amnon Silverstein, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/843,755

(22) Filed: Apr. 30, 2001

(51) Int. Cl. G06F 3/00

(52) U.S. Cl. 345/864

(57) ABSTRACT

The present invention is directed to providing an improved user interface for enhancing the manner by which information is entered into a database and later accessed from the database. Exemplary embodiments are directed to the use of an overlay, in the form of a flat digital display, that can be moved about a surface. The position of the movable display is tracked, so that digital content presented on the display is related to a particular position of the display over the document. This capability can be exploited to, for example, permit a much larger image to be viewed using a relatively small, portable display that can be navigated about the larger image. The larger image can optionally include information that, when accessed on the movable display, can be used to link to other information and/or can be used to access executable3 code for performing a desired function.

### BACKGROUND OF THE INVENTION

1. Field of the Invention

The present invention relates generally to displaying information representing a first image of a first size using a display device of a smaller second size and, more particularly, to using a relatively small display device, having a keypad of limited functionality, as a moveable user interface to control information input and access.

2. Background Information

Numerous available products are directed to improving the ease with which a user stores and accesses database information. However, these known techniques do not address the problems associated with devices, such as personal digital assistants (PDAs), wherein the space available for the keyboard or keypad is limited. Typically, information from a physical document is keyed into a digital database from which it can be accessed for display. This keying in, and subsequent accessing, is typically performed with a conventional keyboard, or at best, using a small wheel to select one letter at a time.

Scanners are also known which permit physical documents to be digitized in advance so that a user can interact electronically with the document using the PDA. Although a user can display the digital document and navigate the displayed document on the PDA display, this navigation is relatively crude in that a limited number of relatively small keys provided on the PDA must be used. Alternately, the image can be displayed on the display of a desktop or laptop computer, and navigated using a mouse which can interact with software buttons displayed along side the image.

Although numerous user interfaces are known for storing and accessing digital information, it would be desirable to further simplify, and at the same time, enhance the manner by which information is remotely entered into a digital database and accessed using, for example, a relatively small display like that associated with a PDA.

### SUMMARY OF THE INVENTION

The present invention is directed to providing an improved user interface for entering information into a database and for later accessing information from the database. Exemplary embodiments are directed to the use of a flat display, that can be moved about a surface. The movement of the movable display is tracked so that digital content presented on the display is related to a movement of the display over the surface. This capability can be exploited to, for example, permit a much larger image to be remotely viewed using a relatively small, portable display that can be navigated about the larger image. The larger image can optionally include information that, when accessed on the movable display, can be used to link to other information and/or can be used to access executable code for performing a desired function.

Generally speaking, the present invention is directed to an apparatus and associated method for interfacing with an image. According to exemplary embodiments, the apparatus is configured as a movable display comprising: means for detecting movement of the movable display over a first surface; and means for correlating the movement of the movable display to information representing a portion of a first image stored in a database, and for presenting the information on the movable display. Exemplary embodiments permit a user to selectively interact with the portion of the first image presented on the movable display. For example, where the first image is an image of a keyboard (that is, a virtual software, or keyboard), the movable display can be used to navigate about the keyboard and to selectively activate keys on the virtual keyboard.

### DESCRIPTION OF THE DRAWINGS

The present invention will now be described by way of exemplary embodiments as illustrated in the following drawings:

FIGS. 1A-1B show an overview of an exemplary embodiment of a movable display according to the present invention;

FIG. 2 shows an exemplary flowchart of operation associated with the FIG. 1 movable display;

FIG. 3 shows an alternate embodiment of the present invention;

FIGS. 4a and 4b show an exemplary embodiment which includes a motion sensor configured as a modular unit; and

FIG. 5 shows an exemplary modified display of an image in accordance with an alternate embodiment.

### DETAILED DESCRIPTION OF THE PREFERRED EMBODIMENTS

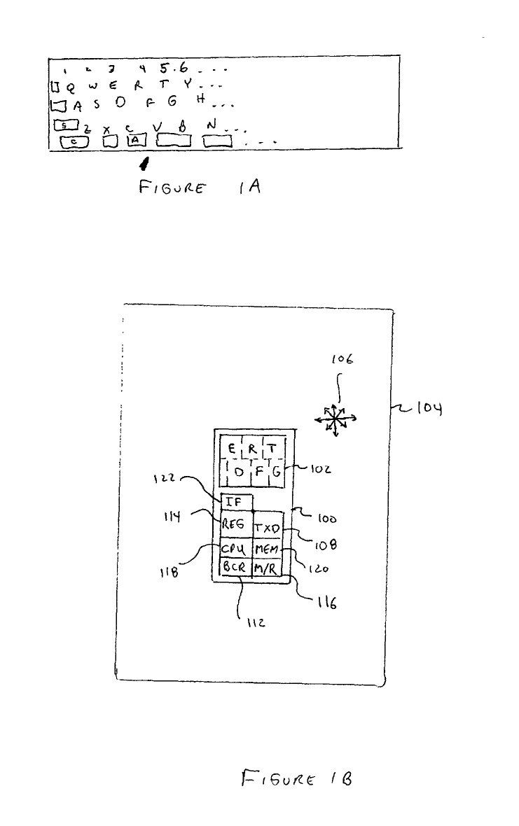

FIG. 1A shows a first image stored in a database, the first image representing a conventional keyboard (all keys are not illustrated). FIG. 1B shows an apparatus, represented as a movable display 100, for displaying information in accordance with an exemplary embodiment of the present invention. The movable display 100 has a display screen 102, and can be configured similar to that described in copending U.S. Application Serial No. ______, entitled METHOD AND APPARATUS FOR VIRTUAL INTERACTION WITH PHYSICAL DOCUMENTS (Attorney Docket No. 10003870/004), filed Dec. 27, 2000, wherein a hand held display apparatus available as the Jornada™ 540 series from Hewlett Packard is described. This display screen 102 can be a flat screen housed in a case, and the display apparatus can include a thumb wheel for magnifying and/or reducing the magnification of a displayed image. Such a feature can be used in accordance with exemplary embodiments of the present invention to control the size of a displayed digital image, and thus, the portion of the first image correlated to the display screen 102.

The display apparatus is configured in accordance with the FIG. 1 embodiment with means for detecting movement of the movable display relative to a first surface 104, such as a table, or any other suitable surface in any direction (as represented by arrows 106). The exemplary movable display 100 can be configured to include a transducer 108, like that included in a conventional mouse. By correlating detected movement of the movable display 100 to a position on the digitally stored image of FIG. 1A, information associated with that position can be extracted and presented on the display screen 102.

Of course, means can be provided to permit the movable display to initially determine which image is to be navigated using the moveable display. For example, each image stored in a given database can have an associated code (e.g., identification number) which the user can initially key into the movable display via a keyboard. Alternately, physical documents which correspond to each image can each include a barcode that can be read by a barcode reader (BCR) 112 included in the movable display. Known image recognition systems, readily available, can also be used to identify a particular document. Upon determining what image is to be navigated, the display screen can be used to access information corresponding to that image from a database.

Registration of the movable display to an initial position within the image is not necessary, since it is only the relative position of the moveable display that is of interest. For example, after initially detecting an image that is to be navigated, the movable display can include a registration key 114 (similar to the left button of a conventional mouse) that can be activated (e.g., depressed) to select a start position for navigation using the movable display. Positions of the display relative to the image can be tracked as the display is moved about the surface 104. Those skilled in the art will appreciate that it is only necessary that the relative position of the movable display to the surface, and thus, to the image, be ascertained.

Having provided means to detect movement of the movable display relative to a surface, this detected movement can be used to access information from a database which stores the FIG. 1A image for presentation on the display screen 102. Accordingly, the exemplary movable display 100 of FIG. 1 includes means, such as a processor (CPU) 118 and associated memory 120, for correlating detected movement of the movable display to information (i.e., digital content) stored in the database as a representation of the FIG. 1A image, and for presenting information on the movable display. In a sense, the movable display serves as a pointing device, which allows the user to point to a given location on the image, and to access information from a remote location which corresponds to that point on the image.

For example, the processor and associated memory included in the readily available Jomada 540 series device, or any other suitable processor and memory, can be used to translate detected movement of the movable display into movement about a displayed image that has been accessed at a given database address, URL address, or any other desired link to information stored elsewhere. Information available at a link associated with a particular point on the image can also be accessed and retrieved for display on display screen 102. The information can include text based information, numeric information, graphical information, or any combination thereof. The information displayed can include access to blocks of information, such as a web page, which can then be further explored using keys or buttons included on the movable display 100. For example, the user, having access to a particular web page based on a selection of the page using the movable display, can then use the display to move about the web page, and to access other web pages.

Assume, for example, that the image to be navigated is an image of a conventional keyboard as shown in FIG. 1A. The entire image can correspond to the keyboard, or can correspond to any image which includes, at least in part, the FIG. 1A keyboard as a subimage. Having registered a relative position of the movable display to the image (e.g., by activating a hardware key on the moveable display), movement of the movable display over the surface 104 can be tracked. This movement can be correlated to a database or Internet site which includes a complete version of the image. More specifically, movement of the movable display can be correlated to an address at which a portion of the image is stored, for access and display on the display screen 102. Exemplary embodiments can be configured to provide a correlation of movement of the movable display to any desired output information in any desired form. To ensure that portions of the image will be oriented on the movable display in a manner desired by the user, the exact orientation of the display relative to the surface can also be detected. This can be achieved, for example, by tracking enough positional coordinates of the movable display 100 relative to the surface 104 that changes in the orientation of the display screen relative to the surface can be determined.

As the display screen 102 is moved over the surface 104, the database can be repeatedly accessed in real time to update the display screen, and provide an on-the-fly display for any given portion of the image. In a sense, the display screen acts as a “lens” or magnifying glass to present any desired portion of the image, with any desired enlargement/reduction, to the user as the “lens” is moved about the surface.

The exact manner in which the information is displayed, can of course, be altered in any number of ways too numerous to mention here, but readily apparent to those skilled in the art. Similarly, the exact presentation can be altered in any number of ways.

In alternate embodiments, hardware keys included on the movable display can be provided to permit any of a variety of functions. For example, hardware keys 116 can be included to permit magnification/reduced magnification of the displayed image as was already mentioned. Similarly, keys can be included to permit rotation of the displayed image, to control color of the displayed image, font of the displayed text, or to alter any other characteristics of the displayed text, numeric, audio, tactile or graphical information. Keys can be provided to further access additional information associated with the displayed imagery. For example, in the context of the FIG. 1 example, wherein a software keyboard is displayed, hardware or software keys included on the movable display, can be used to activate a key pointed to on the keyboard (e.g., execute keyboard functions) relative to a separate display. By positioning the moveable display at a position where a desired software key of a keyboard is displayed, and by activating a hardware key (e.g., similar to a mouse key) or software key on the moveable display (e.g., using a touch sensitive screen), the particular letter associated with the key can be typed into a computer system (for example, into a word processing document displayed in a desktop computer). The moveable display can include any additional desired functionality including, but not limited to, accessing dictionary definitions of words in the displayed image, linking to other addresses of interest, and so forth.

The movable display can access information via an onboard database (such as the image of the keyboard being navigated in the foregoing example), and in this sense, can be completely self contained. Alternately, to provide increased flexibility, the movable device can include a wired or wireless link to a remote database, such as a web site included on the World Wide Web, accessed, for example, via an interface 122 which communicates with a desktop computer or server. Such an interface is well known and need not be described herein in detail.

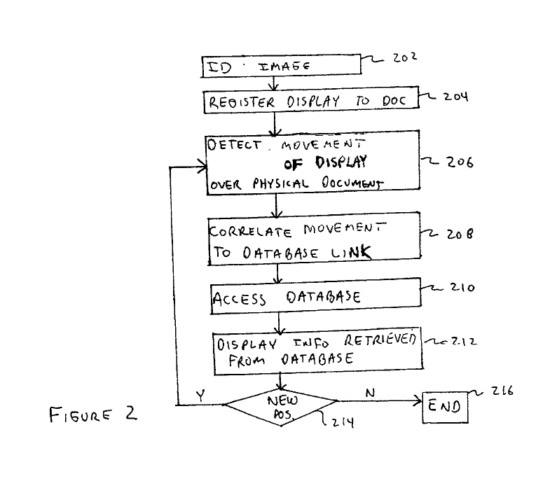

FIG. 2 shows an exemplary flow chart for the processes carried out by the processor 118 of the exemplary FIG. 1 movable display 100. In step 202, the image to be navigated is identified using, for example, some identification number, barcode or other document identification technique. Alternately, an image can be set in advance on the display screen 102 (such as a menu or an initial keyboard) that can be navigated using the movable display to select a desired image.

In step 204, the movable display is registered to the image so that an initial position of the movable display is established. Afterwards, movement of the display can be tracked as the movable display is relocated about the surface 104. Again, this registration can be achieved by, for example, activating one of the keys 116 on the movable display to establish an initial (0,0) position.

In step 206, the detected movement of the movable display relative to the surface 104 is translated into a proportional (or, if desired, non-proportional) movement within the image. In step 208, an output from the transducer 108 associated with the movable display, is correlated to a database link (e.g., database address). In an exemplary embodiment, the onboard transducer 108 produces output information representing the movement of the movable display over the surface 104. Using a look-up table associated with memory 120, the movable display correlates detected amounts of movement to an address (i.e., using an indirect address technique). The CPU 118 of the movable display 100 then accesses a database in step 210. Again, the database can either be an onboard database, or can be a database accessed through either a wired or wireless link of the interface 122 to another computer, or to a server. For example, the database can be accessed over the Internet.

In step 212, the information from the database is retrieved and forwarded to the display screen 102 of the movable display. In step 214, the on-board processor determines whether the movable display has been repositioned based on outputs from the transducer 108. If so, a new position of the display is detected in step 206, and the display screen 102 updated accordingly. Alternately, if the display has not been repositioned, then the display screen retains the information previously displayed, and operation proceeds to the END block 216 until further movement of the movable display reactivates the sequence of steps beginning with step 206.

The foregoing embodiments are by way of example only, and numerous alternate embodiments will be readily apparent to those skilled in the art. In alternate embodiments, relative movement of the moveable display over the surface can be detected in any desired manner. For example, the movement of the moveable display can be detected by monitoring the position of the movable display using any known detection technique including, but not limited to, use of a passive board in conjunction with a movable display that, via a wired or wireless link, transmits detected changes in position (e.g., via an infrared link). The relative change in positional information can be output using any known position detection system.

Tracking marks can also be established (e.g., printed, formed or embedded) on/in a transparent-semi-transparent sheet that is placed over the surface. The marks can be any visible marks and/or can be invisible, for example ultraviolet (UV), polarization, microprinting, gloss differences, conductivity changes, dielectric strengths, tactile bumps, or any other discernible type of marking.

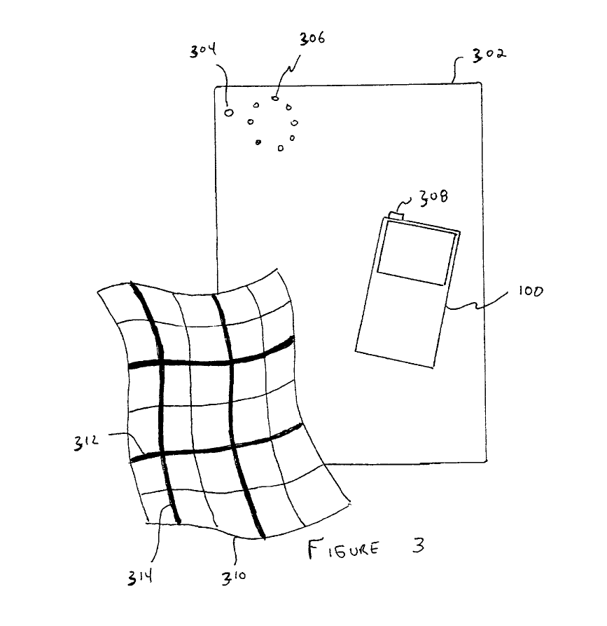

Other known techniques for detecting movement which can be used with the present invention include the known vortac radio navigation technique, which can be implemented using an infrared port on the movable display. More particularly, and by way of example, FIG. 3 shows a plurality of diodes 304/306 included on a passive tablet 302 at a fixed location. One of the diodes 304 can serve as a diode used to create a start pulse. The remaining diodes 306 can be configured in a circle, adjacent the single diode, and flash in sequence to form an electrical rotation. An infrared detector 308 included on the movable display 100 can sense the flash from the single diode as the start of a motion detection operation. The arrangement of circular diodes can then sequentially emit flashes, and the detector on the movable display call sense when light from each of the diodes in the rotational sequence is detected. Based on the detection of the initial start pulse from the single diode 304, relative to the detection of a flash from each of the diodes arranged in the circle, the movable display can determine its orientation relative to the fixed diodes, and thus can ascertain movement from changes in absolute position coordinates.

In accordance with an alternate embodiment, indicia written on or embedded in the surface, can be used to detect movement of the movable display. For example, the surface, or an overlay placed on the surface, can be printed in advance with a navigational grid of lines, such as alternating thick and thin lines. Movements of the movable display 100 over the surface can be tracked by monitoring the number of thick and thin lines detected. Changes in direction can be detected by optically monitoring whether the movable display is transitioning from a thin line to a thick line or vice verse. The thick and thin lines can be both horizontal lines 312 and vertical lines 314 to form a cross grid, with the proximity of adjacent lines to one another being spaced to achieve a desired resolution of position detection. Of course magnetic, fluorescent or infrared inks, or any other visible or invisible inks, or other indicia can be used as well. Known techniques involving use of the global positionary system (GPS), laser interferometry, radar positioning and so forth can also be used. In addition, relative movement of the display can be tracked using mechanical detectors such as gyros, tracking wheels or balls, accelerometers and so forth. Acoustic defactors based on, for example, sonar or surface wave positioning can also be used.

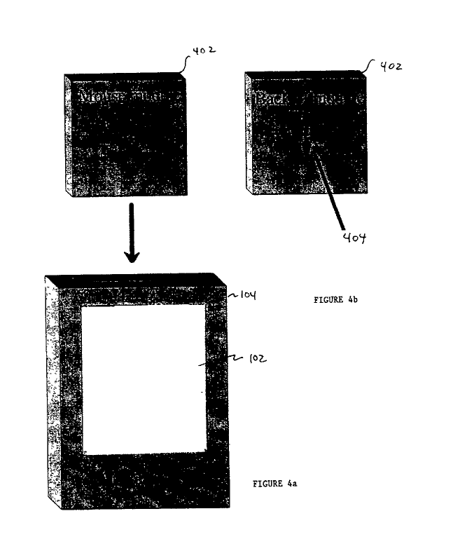

Optical sensors, such as the optical tracking sensors readily available as, for example, with respect to the solid state HDNS-2000 optical mouse sensor available from Agilent Technologies, Inc., or any other tracking system can also be used. FIG. 4a shows an exemplary embodiment wherein the tracking sensor is configured as a modular unit 402 that can be inserted into the movable display 100. FIG. 4b shows a back of the module, wherein a sensor 404, such as an optical mouse, is exposed, and can be used in known fashion to track relative motion of the display apparatus with respect to a given surface.

Those skilled in the art will appreciate that as the display screen 102, any available display can be used. For example, any flat panel display, or any other display can be used. In addition, a touch sensitive display can be used, and can provide any functional attributes desired by the user. For example, the touch sensitive display can be configured to permit the user to magnify or reduce magnification of a particular portion of the displayed image. Thus, the touch sensitive display can be configured to include buttons for performing any of the functions described herein, or any additional functions apparent to those skilled in the art.

Those skilled in the art will also appreciate that while access to displayed imagery using the movable display 100 has been described herein, access can also be provided to audio databases to provide audio outputs corresponding to given positions of the movable display over the physical document. For example, in the FIG. 1 example, access to a database using the movable display 100 can result in an output of sound. Those skilled in the art will appreciate that sounds associated with each of the characters of the keyboard can be stored in the database and simply accessed based on a “pointing” of the movable display at a particular location on the physical document. In addition, tactile outputs (e.g., mouse vibrations) could be provided as an exemplary form of tactile feedback based on the position of the movable display over the document. For example, Logitech Corp. manufactures a mouse with a vibration capability that could be used in accordance with the present invention to provide such a feature.

In accordance with alternate exemplary embodiments, a modified display of the image can be used to assist the user in navigating the image by permitting the user to see an entire image which is to be navigated using a reduced size display. To permit a relatively small display screen to display a much larger image, without requiring the entire image to be produced at a reduced magnification which is difficult for the user to view, exemplary embodiments of the present invention can be configured to distort at least a portion of the image. For example, portions of the image which are not of immediate interest to the user can be condensed, and the remaining portions of the image can be displayed with normal resolution.

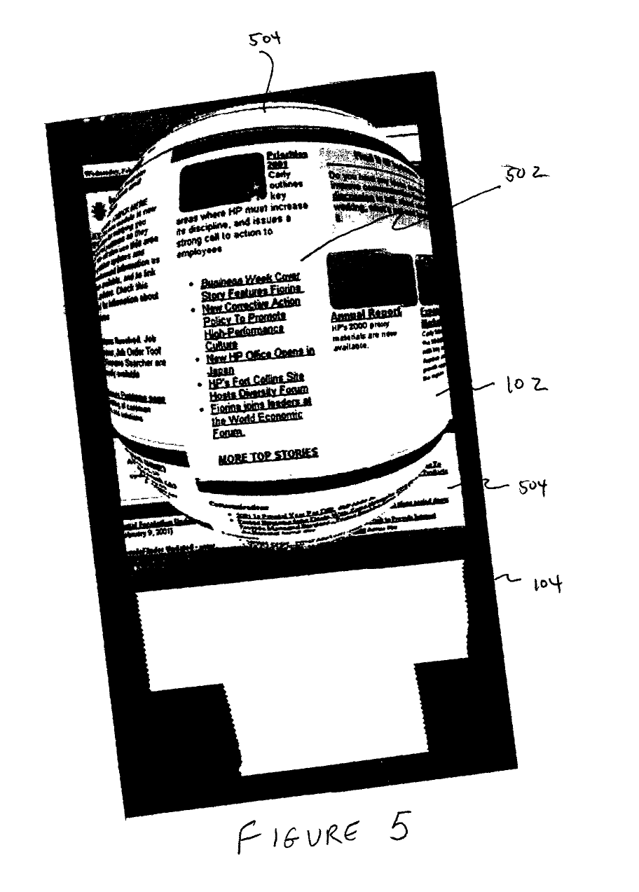

FIG. 5 shows one example where, an image to be displayed (such as a web page which has just been accessed), is distorted at the edges of the display screen 102 of display apparatus 104. This can be achieved using, for example, a distorted map with grids that are configured to be fine at the edges. As shown in the FIG. 5 example, the resultant image has a high resolution and flat configuration at the center 502 of the image, and is condensed at the edges 504 to have a lower resolution and rounded configuration. Thus, a first portion of the image, such as the center of the image, is displayed at normal resolution, and a second portion of the image, such as the perimeter of the image, is distorted (e.g., displayed at a reduced resolution with which the first portion is displayed). As the movable display 100 is moved relative to a given surface, the portion of the image which is distorted versus the portion of the image which appears normal can be altered in accordance with display apparatus movement. This facilitates navigation about a larger image that is displayed on the relatively smaller display of the display apparatus.

In an exemplary embodiment, the foregoing effect can be achieved by initially copying an entire image at multiple resolutions to permit any desired portions of the image to be displayed at any of varying resolutions. During display, a predetermined portion of the display screen (e.g., a center portion of desired size) can be set to display the portion of the image appearing therein at normal resolution. Remaining portions of the display screen can be set to display portions of the image appearing therein at reduced resolution.

Alternately, any digital or optical techniques can be used to magnify the image in a way that preserves horizontal and vertical lines. For example, the image can be resampled with a pair of transformations that are two independent functions of x and y. For any point having coordinates x,y , the resampled image point x′,y′ is computed as x′=f1 (x) and y′=f2(y). Since the new x coordinate is determined only by the old x coordinate, and the y coordinate is fixed in the case of a horizontal line, a horizontal line will stay as a straight horizontal line after the transformation. Any functions can be chosen for f1 and f2. For example, the two functions can be the same smoothly varying magnification function. One function that will work is a cosine function that produces a cylindrical mapping in the two directions. The functions can be changed to magnify specific regions of interest on a page.

The magnification can be used to make a web page on a low resolution device more legible. Although central areas of the image are magnified in the FIG. 5 example, with the rest of the displayed image (e.g., a displayed web page) being compressed, any desired portions of a displayed image can be compressed on the basis of spatial location and/or image content. For example, in an alternate embodiment, a particular portion of the display screen used to display a text column can be magnified. The magnification can be dynamically changed depending on the region selected, and/or on an input from the user, such as a thumbwheel magnification controller, and/or on the basis of image content.

memory buffer can also be used to store the image at the different resolutions. The buffer can be selectively accessed such that the image center (or any desired portion of the image) can be displayed at full resolution, and outer portions of the image can be displayed at decreased resolution. Alternately, any know technique for modifying an image to provide at least a portion of the image at normal resolution, while displaying remaining portions at reduced resolution so that a larger portion of the original image can be viewed, can be used.

An exemplary code set which can be used to implement the image distortion (labeled function I2=orthomag(I1)″ of FIG. 5 based on the selection of two functions x1 and y1 is as follows:

function I2=Orthomag(I1)

dx=1;dy=1;d=0.01;

xmax=size(I1,1);

ymax=size(I1 ,2);

a=sqrt(d);

b=(2+d)/(2*a);

nx=floor((sqrt(xmax+bˆ 2)−b)/a);

ny=floor((sqrt(ymax+bˆ 2)−b)/a);

I2=uint8(zeros(nx*2,ny*2,3));

x2=1;y2=1;

x1=1;y1=1;

for xc=−nx:nx

for yc=−ny:ny

I2(x2,y2,:)=I1(floor(x1),floor(y1),:);

y1=y1+d*abs(yc)+1;

y2=y2+1;

end

y1=1;y2=1;

x1=x1+d*abs(xc)+1;x2=x2+1;

end

Any other known graphical visualization techniques which can be used to present information on the display screen in accordance with the present invention include, but are not limited to, those described in a document entitled “Graph Visualisation and Navigation In Information Visualisation” by Herman, I. et al. available from the Centre for Mathematics and Computer Science (CWI) Information Visualisation Homepage, and a similar documcnt published in the IEEE Transactions on Visualization and Computer Graphics, 6 (1), pages 24-43, 2000. Similarly, techniques described in a document entitled “A Fisheye Text Editor for Relaxed WYSIWIS Groupware”, by Saul Greenberg of the Department of Computer Science, University of Calgary, 1996, ACM SIGCHI 1996 Conference on Human Factors in Computing Systems, Companion Proceedings, pages 212-213 can be used. The disclosures of the foregoing documents are all incorporated herein by reference.

Those skilled in the art will appreciate the exemplary embodiments of the present invention, by providing a “lens” for viewing and navigating portions of a much larger image, can provide access to a limitless database of related information relative to the image. In accordance with exemplary embodiments, a relatively small display affords a user an opportunity to view a much larger virtual work space.

In addition, while exemplary embodiments of the present invention have been described in the context of connecting the movable display with a desktop computer, it can also be connected with any device, including but not limited to a laptop or notebook computer, a personal digital assistant (PDA), a wireless telephone, or any other desired device. Similarly, the movable display can be configured to any size desired by the user, and the exemplary embodiment of FIG. 1 is not limited to relative sizes as shown.

Although the present invention has been shown and described with reference to exemplary embodiments, it will be understood by those skilled in the art that various other changes in the form and details may be made therein without departing from the spirit and scope of the invention.

What is claimed is:

1. A movable display comprising:
means for detecting movement of the movable display relative to a first surface; and
means for correlating movement of the movable display to information representing a portion of a first image stored in a database, and for presenting the information on the movable display.

2. Movable display according to claim 1, wherein the detecting means is a transducer included within the movable display.

3. Movable display according to claim 2, wherein the transducer is used to correlate movement of the movable display to a change in position on a stored image.

4. Movable display according to claim 1, wherein the detecting means is configured to detect orientation of the movable display.

5. Movable display according to claim 1, wherein the correlating means includes:
a processor and associated memory.

6. Movable display according to claim 5, wherein the database is stored in a memory on board the movable display.

7. Movable display according to claim 5, wherein the information is stored in a database remote from the movable display.

8. Movable display according to claim 7, wherein the information stored remote to the movable display is accessed via a wired link.

9. Movable display according to claim 7, wherein the information stored remote to the movable display is accessed via a wireless link.

10. Method for displaying information related to a physical document, comprising:
detecting movement of a movable display relative to a first surface;
correlating movement of the movable display to information representing a portion of a first image stored in a database; and
presenting the information on the movable display.

11. The method according to claim 10, wherein a transducer is used to detect changes in orientation of the movable display.

12. The method according to claim 10, wherein the database is stored in a memory on board the movable display.

13. The method according to claim 10, wherein the information is stored in a database remote from the movable display.

14. The method according to claim 10, wherein the information is stored remote to the movable display and accessed via a wired link.

15. The method according to claim 10, wherein the information is stored remote to the movable display and accessed via a wireless link.

16. The method according to claim 12, wherein the first image is an image of a keyboard that can be operated using the moveable display.

17. The method according to claim 10, wherein a first portion of the first image is displayed at a first resolution and a second portion of the first image is displayed with a reduced resolution relative to the first resolution.
